(19) United States
(12) Patent Application Publication
(10) Pub. No.: US 2003/0192195 A1
(43) Pub. Date: Oct. 16, 2003

(54) Recessed dryer vent system

(76) Inventor: Robert W. Harding, Springville, UT (US)

Correspondence Address: Angus C. Fox, III, 4093 N. Imperial Way, Provo, UT, 84604-5386, US

(21) Appl. No.: 10/421,134

(22) Filed: Apr. 22, 2003

Related U.S. Application Data
(63) Continuation-in-part of application No. 10/035,971, filed on Nov. 9, 2001, now Pat. No. 6,550,157.

(51) Int. Cl. F26B 11/02

(52) U.S. Cl. 34/140

(57) ABSTRACT

A clothes dryer vent system is designed for hollow walls framed with scantling and covered with sheathing secured to the scantling. A rough-in box has a main body with a substantially planar rear panel, non-parallel curved side panels, a curved bottom panel, and a planar top panel that is generally perpendicular to the rear panel. The side, top and bottom panels intersect and are unitary with the rear panel, with each side panel intersecting and unitary with both top and bottom panels. The main body has a stub connector pipe affixed within the top panel that is designed to accept a 4-inch diameter metal vent pipe that has been compressed to an oval configuration. The stub connector pipe has an internal step that limits the insertion depth of the metal vent pipe. A flexible vent hose mounting insert has a stub pipe extension that fits within the stub connector pipe. The mounting insert has a pair of retaining clips that allow it to be secured to the main body of the rough-in box. This feature greatly facilitates the installation of the flexible vent hose that connects the stub connector pipe to the clothes dryer exhaust vent.

This is a continuation-in-part of application Ser. No. 10/035,971, which issued on Apr. 22, 2003 as U.S. Pat. No. 6,550,157.

### FIELD OF THE INVENTION

This invention relates, generally, to a recessed rough-in box for a dryer vent, to vent assemblies for use in combination with dryer vent rough-in boxes and, more particularly, to dryer vent rough-in boxes and vent assemblies which are designed to work effectively in hollow walls framed with 2×4 scantling lumber.

### BACKGROUND OF THE INVENTION

In 1833, only a year after the city of Chicago began to rise from the treeless glacial plain adjacent lake Michigan, a carpenter from Connecticut named Augustine Deodat Taylor contracted to build a large number of houses in that Illinois city. Taylor responded by building what had become known as balloon frame houses. The walls, ceilings and roofs of a balloon frame structure are constructed from interconnected scantling frames which are subsequently covered. Though Taylor is frequently credited with the invention of the balloon frame structure, it seems that the construction technique emerged over several decades as a popular hybrid of many diverse building methods. In the historic Mississippi River town of Ste. Genevieve, Mo., the French were constructing houses, which still stand, using building methods which were precursors of the balloon frame method. Typically, the French constructed houses with palisade walls-vertical wooden posts placed side by side on 16-inch centers, with a continuous plate nailed across the top. Apparently, the walls were built flat on the ground, then tilted up within trenches dug along the perimeter of the building. Eventually, this palisade construction was modified so that the posts were nailed onto timber sills resting on stone or brick foundations. When standard-size lumber is substituted for the posts, the process is very close to the balloon construction method.

Light-weight, wood-frame houses have become the standard in this country. Because they are quite resistant to destruction in earthquake-prone regions, they are being adopted in faraway places, such as Japan, where killer earthquakes are common.

One of the distinguishing characteristics of wood-frame buildings is that the walls are generally hollow. The hollow walls facilitate the invisible routing of electrical, telecommunications and security system wiring, as well as gas and water pipes. Structural lumber used for nearly all interior walls and for some exterior walls is typically 2×4 scantling having a generally rectangular cross section that measures about 3.8 cm by 8.9 cm (1.5 inches by 3.5 inches). The walls are typically covered with gypsum board sheets that are nailed or screwed to the framing material. For residential applications, the gypsum board sheets have a standard thickness of about 1.25 cm (½ inch). For commercial applications, the thickness of the gypsum board is about 1.59 cm (⅝ inch). Thus, the depth of a standard hollow interior wall, as constructed within the United States, is either 10.15 cm (4.0 inches) or 10.5 cm (4⅛ inches).

Within the past twenty years, it has become customary to install the drain and the hot and cold water taps for a washing machine in a recessed box that is coupled to the drain. Not only is space saved for washer installation, but any leaks from the taps flow into the drain. Clothes dryer vent installations have, as a rule, been notoriously sloppy. Not only has it been customary to terminate the vent pipe flush with the back wall, many builders install dryer vent pipes in 2×4 framed walls. As the width of a 2×4 stud is actually 3½ inches, 4-inch aluminum vent pipes are frequently compressed so that they are of oval cross section. The main problem with using a 4-inch vent pipe in a 2×4 framed is that it must pass through the top plate of the wall. It is nearly impossible to neatly compress an aluminum vent pipe so that will pass through the top plate and still leave a portion of the plate on either side of the pipe. A further problem is the frequent necessity of running the vent pipe between floor joists or trusses. If the vent pipe has been compressed to pass through a 2×4 top plate, there are no elbows available that will mate to a compressed 4-inch vent pipe and then, after the 90-degree bend, revert to 4-inch round pipe. These problems result in very sloppy installations of dryer vents in 2×4 framed walls. If an 90-degree elbow is required after the vent passes through a top plate of the same size, the quality of the installation is typically even worse.

Several U.S. patents have been granted for dryer vent assemblies. A first example is U.S. Pat. No. 5,590,477 to Carfagno, which discloses a dryer venting assembly having upper and lower mating rectangular housings, each of which has a protruding cylindrical flange with an opening into the housing to provide for the intake or exhaust of dryer exhaust gases. The Carfagno device appears to have two drawbacks. Firstly, neither of the housings provides a recess into which an accordioned flexible dryer conduit may be stored so that the dryer appliance may be positioned flush with the rear wall. Secondly, as the 90-degree transitions are not smooth, they will act as lint traps and also hamper the use of a vent-duct clean-out snake, which requires smooth transitions at right-angle junctions. A second example is U.S. Pat. No. 5,476,183 to Harpenau, which discloses a rectangular rough-in box for a dryer vent. This box, while providing room for an accordioned flexible dryer conduit, does not adequately address the problems inherent in installing a dryer vent in a 2×4 framed wall.

What is needed is an easily-installable, recessed rough-in box for terminating a clothes dryer vent, that will fit in hollow walls framed with either 2×4 or 2×6 scantling studs. Also needed is a set of vent pipes, for use in combination with the recessed box, that can fit within a 3½ inch wide cavity and pass through a top plate of the same width, without eliminating nearly all of the material in the top plate, make a smooth 90-degree bend to level, and transition to a 4-inch round vent pipe.

### SUMMARY OF THE INVENTION

The present invention answers the heretofore expressed needs for an improved dryer vent system. The vent system is designed for use in hollow walls that are framed with scantling and covered with sheathing secured to the scantling, and that have a hollow interior space that is uniformly at least about 3½ inches wide. The vent system includes a preferred embodiment rough-in box for recessed mounting within such a hollow wall. The rough-in box has a main body with a substantially planar rear panel, non-parallel curved side panels, a curved bottom panel, and a planar top panel that is generally perpendicular to the rear panel. The side, top and bottom panels intersect and are unitary with the rear panel, with each side panel intersecting and unitary with both top and bottom panels. The main body of the rough-in box also has a depth no greater than about 4 inches (3½ inches, plus ½ inch for the thickness of standard-thickness gypsum board), and a stub connector pipe affixed within said top panel, the stub connector pipe is designed to accept a 4-inch diameter metal vent pipe that has been compressed to an oval configuration. The stub connector pipe has an internal step that limits the insertion depth of the metal vent pipe. A flexible vent hose mounting insert has a stub pipe extension that fits within the stub connector pipe. The mounting insert has a pair of clips that enable it to be reversably secured to the main body of the rough-in box. This feature greatly facilitates the installation of the flexible vent hose that connects the stub connector pipe to the clothes dryer exhaust vent.

The preferred embodiment rough-in box is also equipped with a trim piece which mates with the box, and which conceals the rough edges of abutting gypsum board. It is also equipped with two different mounting systems. The first mounting system is designed for new construction, and employs two sets of stud-mounting supports which clip into the periphery of the main body of the rough-in box. The second mounting system is designed for remodel construction, and employs multiple rotatable pop-out fasteners which enable the box to be inserted into a rectangular opening cut in gypsum board wall sheathing and secured within the opening.

### BRIEF DESCRIPTION OF THE DRAWINGS

FIG. 1 is an exploded view of a preferred embodiment rough-in box for a clothes dryer vent;

FIG. 2 is a front elevational view of the rough-in box of FIG. 1;

FIG. 3 is a right-side elevational view of the rough-in box of FIG. 1;

FIG. 4 is a top plan view of the rough-in box of FIG. 1;

FIG. 5 is an isometric view of the rough-in box of FIG. 1, showing primarily the right side, top and interior thereof;

FIG. 6 is an isometric view of the rough-in box of FIG. 1, showing primarily the right side, bottom and rear thereof;

FIG. 7 is a front elevational view of the flexible hose mounting insert;

FIG. 8 is a top plan view of the flexible hose mounting insert of FIG. 7;

FIG. 9 is a cross-sectional view of the flexible hose mounting insert of FIG. 7, taken through line 9-9 of FIG. 8;

FIG. 10 is an isometric view of the flexible hose mounting insert of FIG. 7;

FIG. 11 is a front elevational view of a short stud mounting support;

FIG. 12 is a top plan view of the short stud mounting support of FIG. 11;

FIG. 13 is a clip end view of the short stud mounting support of FIG. 11;

FIG. 14 is an isometric view of the short stud mounting support of FIG. 11;

FIG. 15 is a front elevational view of a long stud mounting support;

FIG. 16 is a top plan view of the long stud mounting support of FIG. 15;

FIG. 17 is a stud mounting end of the long stud mounting support of FIG. 15;

FIG. 18 is a front elevational view of a rotatable retaining clip;

FIG. 19 is a top plan view of the rotatable retaining clip of FIG. 18;

FIG. 20 is a pivot end view of the rotatable retaining clip of FIG. 18; and

FIG. 21 is an isometric view of the rotatable retaining clip of FIG. 18.

### PREFERRED EMBODIMENT OF THE INVENTION

The improved, recessed rough-in box for terminating a clothes dryer vent will now be described with reference to the attached drawing figures. It should be understood that the figures are not necessarily drawn to scale and are intended to be merely illustrative of the invention. The preferred embodiment of the recessed, or flush mountable, clothes dryer vent rough-in box is designed for installation within hollow walls framed with scantling studs that are at least 3½ inches wide.

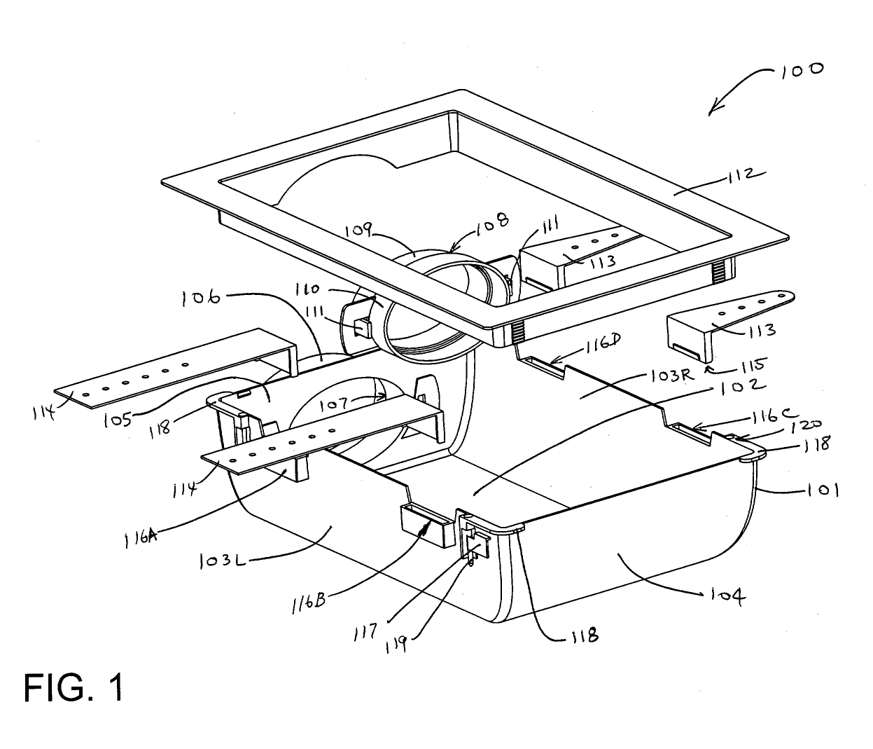

Referring now to FIG. 1, the preferred embodiment recessed clothes dryer rough-in box 100 has a main body 101 with a substantially planar rear panel 102, nonparallel curved side panels 103L and 103R, a curved bottom panel 104, and a planar top panel 105 that is generally perpendicular to the rear panel 102. The side, top and bottom panels intersect and are unitary with the rear panel, with each side panel intersecting and unitary with both top and bottom panels. The main body 101 of the rough-in box 100 also has a depth d that is no greater than about 4 inches (3½ inches, plus ½ inch for the thickness of standard-thickness gypsum board). The main body 101 also incorporates a stub connector pipe 106, that is affixed within the top panel 105. The stub connector pipe 106 is designed to accept a 4-inch diameter metal vent pipe (not shown) that has been compressed to an oval configuration. The stub connector pipe 106 has an internal step 107 that limits the insertion depth of the metal vent pipe. A flexible vent hose mounting insert 108 has an upper stub pipe extension 109 that fits within the stub connector pipe, and a lower stub pipe extension 110 to which a flexible dryer vent hose may be attached. The mounting insert 108 has a pair of retaining clips 111 that enable it to be reversably secured to the main body 101 of the rough-in box 100. This feature greatly facilitates the installation of the flexible vent hose that connects the stub connector pipe to the clothes dryer exhaust vent.

The preferred embodiment rough-in box is also equipped with a trim piece 112, which mates with the box, and which conceals the rough edges of abutting gypsum board. It is also equipped with two different mounting systems. The first mounting system is designed for new construction, and employs a pair of short stud-mounting supports 113 and a pair of long stud-mounting supports 114, which clip into the periphery of the main body of the rough-in box. The clip end 115 of each stud-mounting support 113 or 114 may be inserted and reversably secured into any of the four clip receptacles 116A, 116B, 116C or 116D which are molded into the main body 101. The second mounting system is designed for remodel construction, and employs multiple rotatable, pop-out fasteners 117 and a partial mounting flange 118, which enable the box to be inserted into a rectangular opening cut in gypsum board wall sheathing and secured within the opening using screws 119, the heads 120 of which are accessible on the partial mounting flange 118.

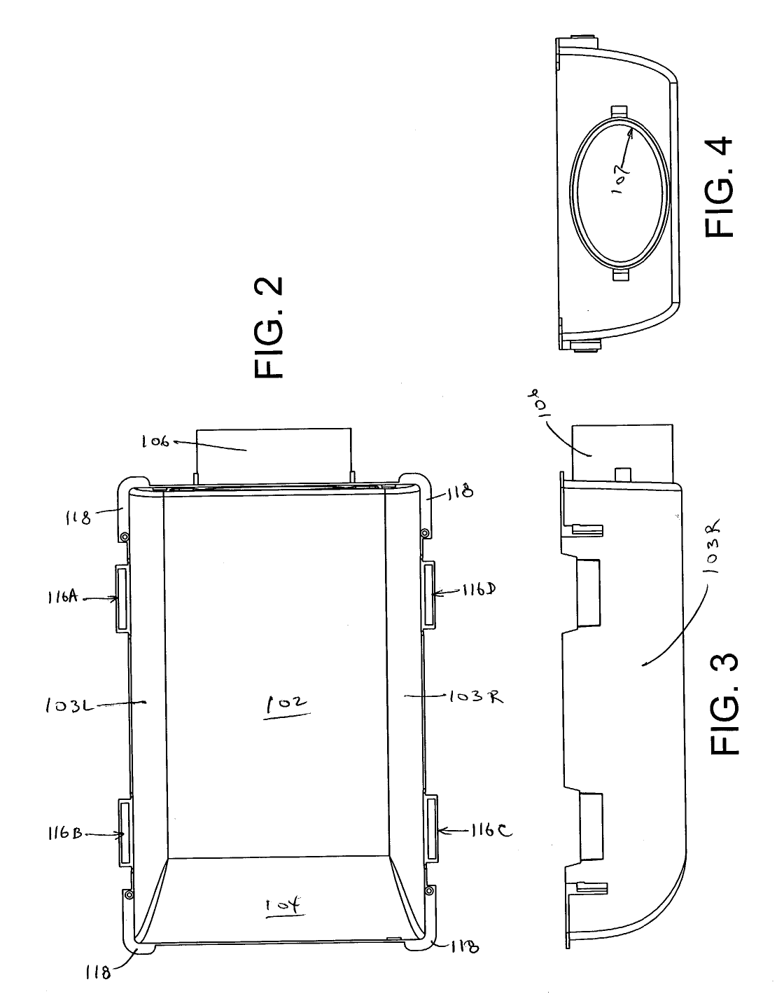

Referring now to FIGS. 2, 3, 4, 5 and 6, the main body 101 of the rough-in dryer vent box 100 has been stripped bare so that its individual features are visible.

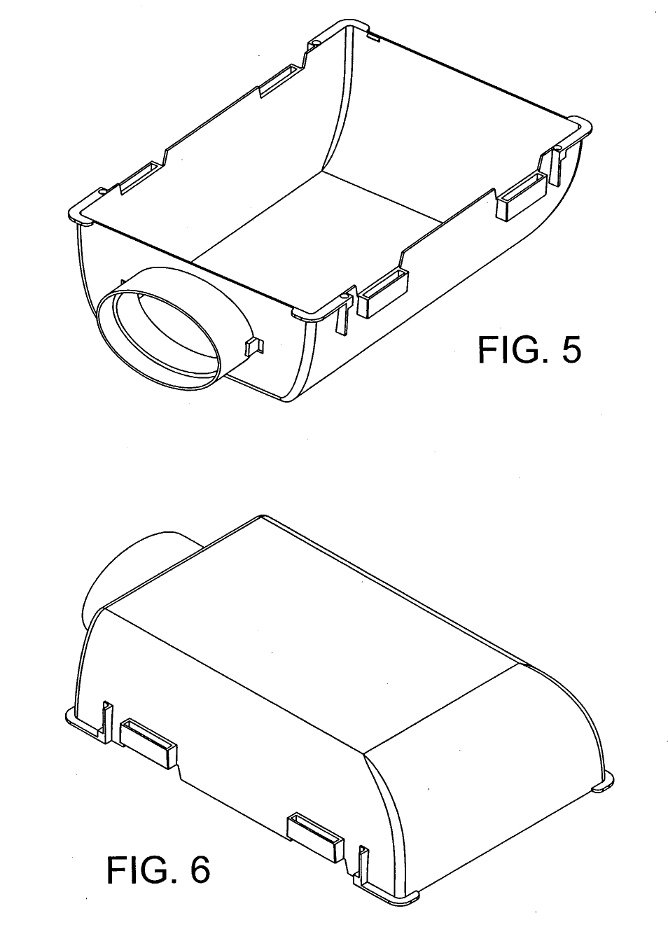

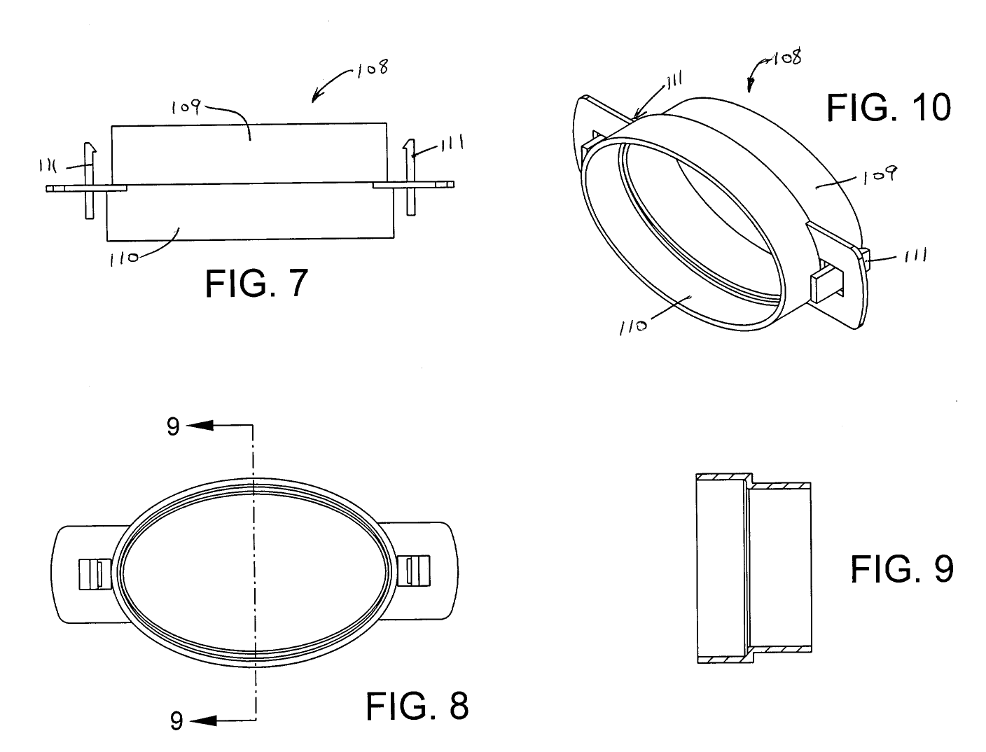

Referring now to FIGS. 7, 8, 9 and 10, the flexible vent hose mounting insert 108 is shown in various views so that its shape may be accurately ascertained. The upper stub pipe extension 109, the lower stub pipe extension 110, and the mounting clips 111 are clearly visible in one or more of these drawing figures.

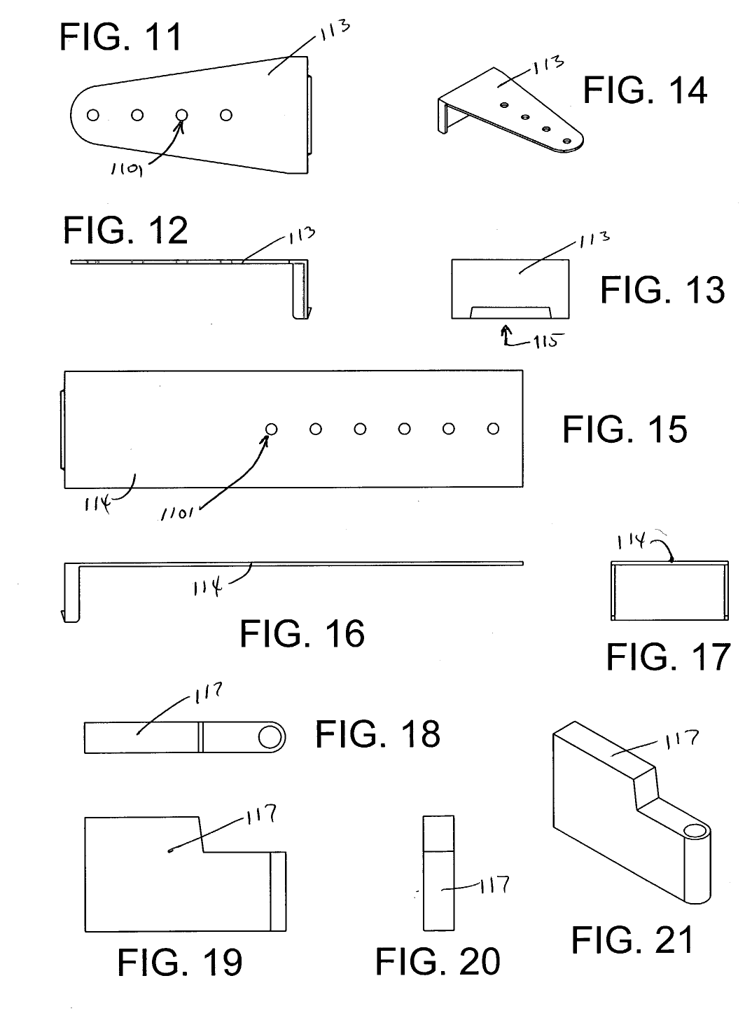

Referring now to FIGS. 11, 12, 13 and 14, the stud-mounting supports of the first set 113 are shown in various views. It will be noted that each support has a plurality of apertures 1101, through which the support may be nailed to a framing stud.

Referring now to FIGS. 15, 16 and 17, the stud-mounting supports of the second set 114 are longer than those of the first set 113, though functionally identical. Taken together, the first and second sets 113 and 114, respectively, allow the rough-in dryer vent box to be mounted between framing studs that positioned 12 to 21 inches between centers. As the stud-mounting supports of both sets are reversible, the position of the rough-in box 100 is infinitely adjustable between the studs to which it is secured.

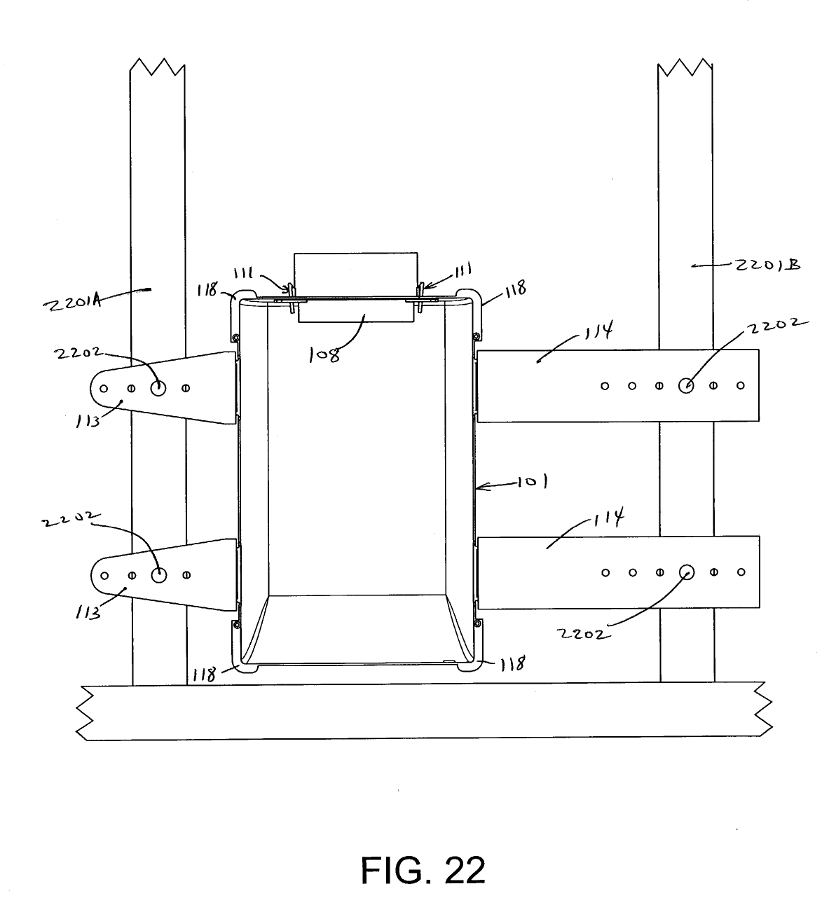

Referring now to FIGS. 18, 19, 20 and 21, the rotatable pop-out fasteners are shown in various views. U.S. Pat. No. 6,550,157 covers this feature in greater detail.

Referring now to FIG. 22, a preferred embodiment clothes dryer vent rough-in box 100 has been installed between a pair of studs 2201A and 2201B. In addition, the flexible vent hose mounting insert 108 has been installed within the main body 101, with each retaining clip 111 secured to the main body 101. A nail 2202 through each stud mounting support anchors the rough-in box 100 to the studs 2201A and 2201B.

Although only a single embodiment of the improved recessed dryer vent rough-in box have been heretofore described, it will be obvious to those having ordinary skill in the art that changes and modifications may be made thereto without departing from the scope and the spirit of the invention as hereinafter claimed.

What is claimed is:

1. A clothes dryer vent system for hollow walls framed with scantling and covered with sheathing secured to the scantling, said walls having a hollow interior space that is uniformly, at least about 3½ inches wide, said vent system comprising:
a rough-in box for recessed mounting within a hollow wall, said rough-in box having generally planar top and rear panels, curved side panels, and a curved bottom panel, said side panels and said top and bottom panels intersecting and unitary with the rear panel, each side panel intersecting and unitary with both top and bottom panels, said rough-in box also having a depth no greater than about 4 inches, and an oval stub connector pipe affixed within said top panel for receiving a metal vent pipe; and
a vent hose mounting insert having an upper stub pipe extension that fits within the stub connector pipe, and a lower stub pipe extension to which a vent hose may be coupled, said vent hose mounting insert having a pair of retaining clips that allow it to be reversably secured to the main body of the rough-in box.
